(19) United States
(12) Patent Application Publication
(10) Pub. No.: US 2016/0345622 A1
(43) Pub. Date: Dec. 1, 2016

(54) CANDY HOOKAH TIPS

(71) Applicants: Karim Ezzat Mahmoud, Anaheim, CA (US); Danny Cuellar, Garden Grove, CA (US); Gabriel R.C. Salera, Long Beach, CA (US); Vincent Dinh, Fontana, CA (US); John Paul Vega, Santa Ana, CA (US)

(72) Inventors: Karim Ezzat Mahmoud, Anaheim, CA (US); Danny Cuellar, Garden Grove, CA (US); Gabriel R.C. Salera, Long Beach, CA (US); Vincent Dinh, Fontana, CA (US); John Paul Vega, Santa Ana, CA (US)

(21) Appl. No.: 14/724,796

(22) Filed: May 28, 2015

(51) Int. Cl. A24F 1/32; A24F 1/30; A23G 3/36; A24F 7/00

(52) U.S. Cl. CPC A24F 1/32; A24F 7/00; A24F 1/30; A23G 3/36

(57) ABSTRACT

A candy flavored hookah tip that attaches to a hookah mouthpiece, enhancing the smoker's enjoyment by providing the essence of candy flavors without having to deposit flavored tobacco in the hookah, and a method for adding candy flavor to the hookah tip.

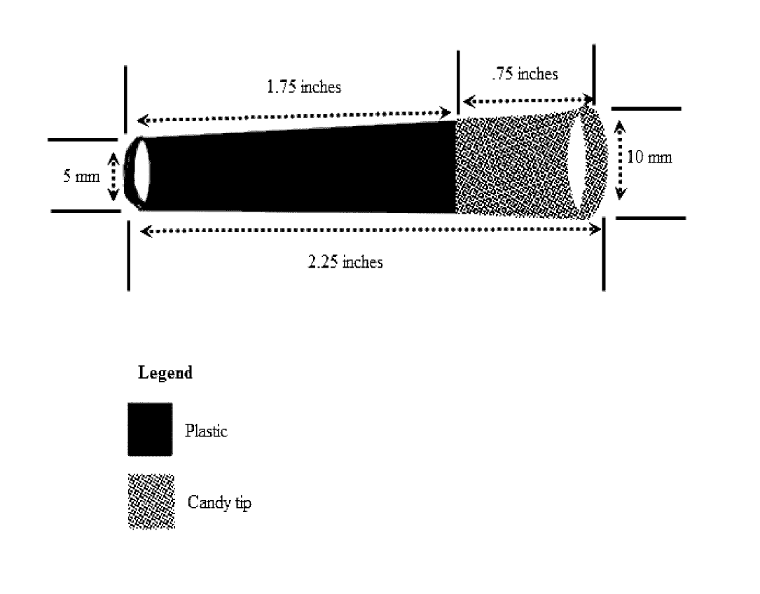

### CROSS-REFERENCE TO RELATED APPLICATIONS

Application No. 62/067,420 (Provisional Patent).

### BACKGROUND OF THE INVENTION

The Candy Hookah Tip applies generally to the field of Tobacco Appliances peculiarly adapted to use by smokers, and more particularly to accessories for smokers.

### DESCRIPTION OF THE PRIOR ART

Pertinent art is found in Class 131, Tobacco, subclass 229.

Examples of relevant patents are U.S. Pat. Nos.: 20140026903 A1, 20130220350 A1, 20140230832 A1,

US Pat. No. 20140026903 A1 allows for the hands free operation of the hookah.

US Pat. No. 20130220350 A1 creates a means for safely holding a hookah mouthpiece for a user in a manner that does not cause a fire hazard or injury to the user, and in a sanitary manner.

US Pat. No. 20140230832 A1 describes a filtering system for removing undesired impurities from the smoke in a hookah.

While the prior art address the issues of safety, comfort and convenience of tobacco smokers who use the hookah apparatus, it does not address the enhancement of recreation and pleasure of smokers. For example, the use of the hookah is a centuries old tradition in which smokers share the hookah, albeit through different mouthpieces. As a consequence, all smokers must necessarily consume the same tobacco, and the same flavor and essence of tobacco.

### BRIEF SUMMARY OF THE INVENTION

The present invention provides a flavored hookah tip that attaches to the hookah, thus enabling different users of the hookah to enjoy different flavors while still sharing the same tobacco in the hookah. The present invention also provides a formula for the flavor and the method for adding different flavors to a standard hookah mouthpiece.

The invention addresses the limitation of hookah users having to consume the same tobacco in a hookah. In contrast, smokers can enjoy different flavors and essences simply by using different flavored hookah tips that can be easily changed and connected to a hookah. At the same time, the invention allows for the enjoyment of different tobacco flavors without having to refill the hookah with different tobacco, thus addressing cost considerations of purchasing more expensive flavored tobaccos.

Finally, the present invention provides a cost efficient and safe method for adding flavor to a hookah tip.

### OBJECTS OF THE INVENTION

One object of the present invention is the provision of a flavored hookah tip.

Another object is to provide the ingredients of the flavor.

Another object of the invention is to provide a method for adding flavor to a hookah tip.

### DESCRIPTION OF THE DRAWING

The drawing shows a side view of the flavored hookah tip, the total dimensions, and the dimension of the portion of the hookah tip that is plastic or candy flavored.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

The present invention consists of a flavored hookah tip that attaches to the mouthpiece of a hookah, which is a centuries old smoking apparatus that is traditionally shared among close friends and family members. The flavored hookah tip in this invention is enhanced with one of several available candy flavors, including mint, strawberry, lemon, watermelon, berry, grape, and other popular flavors.

The ingredients of the flavored portion of the hookah tip consist of Sugar, Corn Syrup, Malic Acid, and 2% or less of: Palm Oil; Natural and Artificial Flavor, Sodium Lactate, Gelatin; Glyceryl Monostearate, Artificial Color (Red 40; Yellow 5, Blue 1, Yellow 6); Sulfur Dioxide, Soy Lecithin and Cornstarch.

The method by which the flavor is added to the hookah tip consists of heating hard candy pieces, at a ratio of 1 ounce (28 grams) of hard candy per hookah tip. The hard candy is heated at a temperature between 200 and 300 degrees Fahrenheit (93 to 148 degrees Celsius), until liquefied. The wider end of the hookah tip is dipped into the liquefied candy in such a way so as to coat the hookah tip with a film not to exceed 2 mm, and so as not to block the cavity of the tip through which the tobacco smoke passes when the hookah is used. (See the drawing.)

The preferred embodiment of the invention consists of a flavored hookah tip measuring 2.25-inches long, a 10 mm diameter cylindrical chamber on one end of the tip through which tobacco smoke passes and where the tip attaches to the hookah mouthpiece, and a 5 mm diameter end that is inserted into the smoker's mouth. This preferred embodiment is added with flavor as described in the process above.

One asset of this invention is its simplicity. The process by which the flavor is added does not require sophisticated equipment or materials. This invention provides a cost effective and simple means by which hookah users can enhance their smoking pleasure by sampling different flavors and essences without having to deposit different types of tobacco in the hookah. In addition, different smokers who are sharing the same hookah can enjoy different flavors even though each smoker is consuming the same tobacco.

Finally, the present invention provides aesthetic value, as the flavored hookah tips emanate different essences.

What is claimed is:

1. A flavored hookah tip wherein smokers of tobacco who use the hookah device can enjoy different flavors without having to deposit different tobacco flavors in the hookah.

2. The flavored hookah tip in claim 1 is disposable, safe, and sanitary.

3. The flavored hookah tip in claim 1 is an economical means for enjoying different flavors without investing in expensive flavored-tobacco

4. A process for adding flavor to a hookah without investment in sophisticated equipment or materials.

5. A formula for ingredients of the flavor.
